(19) United States
(12) Patent Application Publication
(10) Pub. No.: US 2006/0089260 A1
(43) Pub. Date: Apr. 27, 2006

(54) Nitrification inhibitor treatment of grazed pasture soils

(75) Inventors: Jie Hong Di, Christchurch (NZ); Keith Craig Cameron, Canterbury (NZ)

Correspondence Address: CROWELL & MORING LLP;INTELLECTUAL PROPERTY GROUP, P.O. BOX 14300, WASHINGTON, DC, 20044-4300, US

(73) Assignees: Lincoln University, Lincoln, Canterbury (NZ); Ravensdown Fertiliser Co-Operative Limited, Christchurch (NZ)

(21) Appl. No.: 10/522,948

(22) PCT Filed: Aug. 1, 2003
(86) PCT No.: PCT/NZ03/00169

§ 371 Date: Nov. 3, 2005

(30) Foreign Application Priority Data
Aug. 2, 2002 (NZ) 520549

(51) Int. Cl. A01N 25/00

(52) U.S. Cl. 504/116.1

(57) ABSTRACT

A nitrification inhibitor treatment used as a soil mangement tool on grazed pasture soils. The treatment includes the application of nitrification inhibitors in solution form and/or line particle suspension form and/or in crystalline form to treat the whole area of grazed pasture soils to: reduce nitrate leaching; reduce nitrous oxide emissions; reduce postassium, calcium and magnesium leaching; and increase pasture production in both the animal urine patch areas and non-urine patch areas. The nitrification inhibitors can be applied in conjunction with irrigation water, by a spray vehicle or in a similar way to the application of agricultural chemicals.

### FIELD OF THE INVENTION

This invention relates to a soil management tool when used in pasture farming systems to reduce nitrate leaching, reduce nitrous oxide emissions, reduce potassium, calcium and magnesium leaching, and improve pasture production from grazed pasture soils. More particularly it relates to a method for and the delivery of nitrification inhibitors (including dicyandiamide (DCD)) to treat grazed pasture soils to achieve the full range of benefits listed above.

### BACKGROUND ART

Nitrate (NO₃⁻) leaching from agricultural land and the contamination of ground- and surface-waters is a major environmental concern in many countries. This problem is particularly serious in intensive land use areas, where there are high inputs of nutrients in the forms of fertilizers or animal manure or effluents, or where nutrients are returned in the form of urine from grazing animals.

High NO₃⁻—N leaching losses (over 100 kg NO₃⁻—N ha⁻¹ y⁻¹)(when urea fertiliser was applied at 200 kg N ha⁻¹ y⁻¹) have been reported on shallow stoney soils in Canterbury in the South Island of New Zealand. Studies in the UK on beef cattle grassland have recorded NO₃⁻—N leaching losses ranging from 39 to 162 kg N ha⁻¹ y⁻¹.

In intensively grazed sheep, beef and dairy pasture systems, the main source of NO₃⁻—N leached comes from the nitrogen (N) returned in the urine from grazing animals. The N loading rate under a cow urine patch is equivalent to 1000 kg N ha⁻¹ and 500 kg N ha⁻¹ for sheep urine patches. This amount of N is in excess of that which can be taken up by the pasture in a growing season. The surplus N, when converted to NO₃⁻—, is thus prone to leaching when there is drainage through the soil profile.

The New Zealand Ministry of Health has established drinking water guidelines that limit NO₃⁻—N concentration in drinking water to 11.3 mg N L⁻¹. These practices are similar to regulatory or mitigating measures taken by other countries.

Nitrate leaching from soil also increases leaching losses of potassium (K⁺), calcium (Ca²⁺) and magnesium (Mg²⁺), due to the need for a positively charged ‘counter ion’ to balance the negatively charged nitrate (NO₃⁻) ion that is leached. This represents a loss of valuable nutrients that a farmer has to replace in the form of fertilizers.

One of the management measures that has the potential to reduce NO₃⁻, K, Ca and Mg leaching and nitrous oxide emissions from agricultural land is the use of nitrification inhibitors which slow down the conversion of ammonium (NH₄+) to NO₃⁻ in the soil.

Most soils in temperate regions of the world have a net negative charge, therefore NH₄⁺—N is adsorbed onto the soil exchange surfaces, giving a greater opportunity for it to be taken up by plants, immobilized into soil organic matter, or fixed into certain clay mineral interlayers, rather than being leached.

Nitrous oxide (N₂O) is both a greenhouse gas, contributing to global warming, and a gas that can cause depletion of the stratospheric ozone layer. The global warming potential of N₂O in the long-term is about 320 times that of carbon dioxide (CO₂). The amount of N₂O directly emitted from agricultural fields may account for 20-30% of the total N₂O emitted annually from the earth's surface.

In grazed grassland pasture systems, a major source of N₂O emissions is the N returned in animal excreta, particularly in the urine. For example, in New Zealand N₂O emissions from animal excreta account for about 50% of the country's total N₂O emissions. Total N₂O emissions make up about 20% of New Zealand's total greenhouse gas emissions inventory.

A significant reduction of N₂O emissions from animal excreta in grazed pastures will therefore make a significant contribution to reducing total greenhouse gas emissions in New Zealand.

Pasture production under urine patches is higher than surrounding areas because of the N added to the soil by the urine although the efficiency of utilisation is not high.

The applicants enquiries show that nitrification inhibitors have not been used previously to treat the whole area of grazed pasture soils to: (1) reduce nitrate leaching; (2) reduce nitrous oxide emissions; (3) reduce potassium, calcium and magnesium leaching; and (4) increase pasture production in grazed pasture systems, including both urine patch and non-urine patch areas.

A paper by Cookson, W R. and Comforth, I S. published in October 2002 (‘Dicyandiamide slows nitrification in dairy cattle urine patches: effects on soil solution composition, soil pH and pasture yield’. Soil Biology & Biochemistry 34, 1461-1465) simply showed that DCD slowed down the nitrification rate in the soil, as measured in the field. The study did not provide direct evidence to show that the difference in nitrate concentration at the different soil depths was due to leaching. Other processes, e.g. immobilization, plant uptake and denitrification may have caused that difference. The study found no significant response in pasture yield or N uptake to DCD application, which is in contrast to the applicants' findings of increased pasture yield and N uptake, both in the urine and non-urine patch areas. No measurements were made or results reported for nitrous oxide emissions, or potassium, calcium or magnesium leaching losses. As will be seen below, the invention is very different to the work by Cookson and Comforth because their work does not involve treating the total area of soil with a nitrification inhibitor (DCD) to successfully: (1) reduce nitrate leaching; (2) reduce nitrous oxide emissions; (3) reduce potassium, calcium and magnesium leaching; and (4) increase pasture production in grazed pasture systems, including both the urine patch and non-urine patch areas.

A paper by Williamson, J C. et al. in 1998 (‘Reducing nitrogen leaching from dairy farm effluent-irrigated pasture using dicyandiamide’. Agriculture Ecosystems & Environment 69, 81-88) describes the effect of adding a nitrification inhibitor (DCD) to dairy farm effluent prior to application onto the soil. The authors concluded that: “The reduction in N leached achieved by applying DCD was not sufficient to avert high N losses and environmental damage in the case of repeated, high effluent-N loadings during winter”. The invention is very different to their work because their work involves treating dairy farm effluent rather than treating the whole area of grazed pasture soil with a nitrification inhibitor to successfully: (1) reduce nitrate leaching; (2) reduce nitrous oxide emissions; (3) reduce potassium, calcium and magnesium leaching; and (4) increase pasture production in grazed pasture systems, including both the urine patch and non-urine patch areas.

A paper by Thomson, R B. in 1989 (‘Denitrification in slurry-treated soil . . . ’. Soil Biology and Biochemistry 21, 875-882) describes the effect of adding nitrification inhibitors to dairy cattle slurry prior to injection into the soil. The invention is very different to their work because their work involves treating cattle slurry rather than treating the whole area of grazed pasture soil with a nitrification inhibitor to successfully: (1) reduce nitrate leaching; (2) reduce nitrous oxide emissions; (3) reduce potassium, calcium and magnesium leaching; and (4) increase pasture production in grazed pasture systems, including both the urine patch and non-urine patch areas.

A paper by Akai-N; Ishibashi-E; Oya-M; Moritsugu-S. in 2001 (‘Effects of nitrification inhibitors added to cow's urine on environmental burdens from grassland’. Japanese-Journal-of-Soil-Science-and-Plant-Nutrition. 72: 2, 206-213) describes the effect of mixing the DCD with the cow urine before application to a pasture soil. The invention is very different to the Japanese work because their work involves treating animal urine rather than treating the whole area of grazed pasture soil with a nitrification inhibitor to successfully: (1) reduce nitrate leaching; (2) reduce nitrous oxide emissions; (3) reduce potassium, calcium and magnesium leaching; and (4) increase pasture production in grazed pasture systems, including both the urine patch and non-urine patch areas.

A paper by Wozniak et al., in 1999 (‘Nitrification inhibitors for economically efficient and environmentally friendly nitrogen fertilization’. IFA Agricultural Conference on Managing Plant Nutrition. 29 Jun. 1999. Barcelona, Spain) reviews the use of nitrification inhibitors to manage nitrogen supply from fertilizers. The invention is different to their work because their work involves treating fertilisers rather than treating the whole area of grazed pasture soil with a nitrification inhibitor to successfully: (1) reduce nitrate leaching; (2) reduce nitrous oxide emissions; (3) reduce potassium, calcium and magnesium leaching; and (4) increase pasture production in grazed pasture systems, including both the urine patch and non-urine patch areas.

A patent specification by Young et al. 1994 (U.S. Pat. No. 5,332,580)‘Fumigation method employing an aqueous solution comprising a hexametaphosphate, a thiocarbonate, and a sulfide’ describes soil fumigation techniques and benefits and is therefore not directly relevant to the invention because the invention is not concerned with fumigation of soil.

A website page by Landcare Research in 2003 (‘Reducing nitrous oxide flux from animal wastes’. http://www.landcareresearch.co.nz/research/greenhouse/climate . . . ) describes the effect of adding a nitrification inhibitor (DCD) to dairy cattle effluent to reduce nitrous oxide emissions following land application of the mixture. The invention is very different to the Landcare Research work because their work involves treating animal effluent rather than treating the whole area of grazed pasture soil with a nitrification inhibitor to successfully: (1) reduce nitrate leaching; (2) reduce nitrous oxide emissions; (3) reduce potassium, calcium and magnesium leaching; and (4) increase pasture production in grazed pasture systems, including both the urine patch and non-urine patch areas.

A web page published by FRST in 1995 ‘Global effect of nitrogen’ http://www.frst.govt.nz/publications/foundation/20/9.cfm describes the possible use of nitrification inhibitors applied with dairy shed effluent or other wastes, such as piggery wastes. The invention is very different to the work (by Landcare Research) because their work involves treating dairy shed effluent rather than treating the whole area of grazed pasture soil with a nitrification inhibitor to successfully: (1) reduce nitrate leaching; (2) reduce nitrous oxide emissions; (3) reduce potassium, calcium and magnesium leaching; and (4) increase pasture production in grazed pasture systems, including both the urine patch and non-urine patch areas.

DCD has also been used in cropping systems (in conjunction with fertilizers) but this is not relevant because our invention refers to treating the whole area of grazed pasture soil with a nitrification inhibitor to successfully: (1) reduce nitrate leaching; (2) reduce nitrous oxide emissions; (3) reduce potassium, calcium and magnesium leaching; and (4) increase pasture production in grazed pasture systems, including both the urine patch and non-urine patch areas.

It is an object of this invention to address the foregoing problems and to provide a useful alternative choice.

Further aspects and advantages of the present invention will become apparent from the ensuing description which is given by way of example only.

### STATEMENTS OF INVENTION

The invention in a first aspect provides for a soil management tool when used in pasture farming systems including the application of nitrification inhibitors in solution form and/or fine particle suspension form and/or in crystalline form to treat the whole area of grazed pasture soils as a very effective management tool to: (1) reduce NO₃⁻—N leaching; (2) reduce nitrous oxide emissions; (3) reduce potassium, calcium and magnesium leaching; and (4) increase pasture production in both the animal urine patch areas and non-urine patch areas.

The nitrification inhibitor can be applied in conjunction with irrigation water, by a vehicle or in a similar way to the application of agricultural chemicals.

The invention provides in another aspect a delivery mechanism for applying a nitrification inhibitor in solution form and/or fine particle suspension form and/or crystalline form to the whole area of the soil in a grazed pasture system.

The invention provides in a preferred aspect a solution and/or fine particle suspension of nitrification inhibitor when applied at a frequency and timing to a grazed pasture to reduce NO₃⁻—N leaching by 76% for urine-N applied in the autumn, and by 42% for urine-N applied in the spring, giving an annual average reduction of 59%, which is equivalent to reducing the NO₃⁻—N leaching loss in a grazed pasture from 118 to 46 kg N ha⁻¹ y⁻¹ (Table 1 below).

An alternative means of delivering the inhibitor can be in a crystalline form, either on its own or in combination with other products, which allows for rainfall or irrigation to dissolve it into soil.

The invention also reduces nitrous oxide emissions (Table 3 and FIG. 4); reduces potassium, calcium and magnesium leaching losses (Table 4); and increases pasture production (FIG. 2 and Table 2).

Two of the most commonly used nitrification inhibitors are dicyandiamide (DCD) and nitropyrin. DCD has several advantages, which make it a desirable choice over others. It is cheaper to produce; it is water soluble and can be applied in solution form and/or fine particle suspension form; and importantly, it decomposes completely in the soil into NH₄⁺ and CO₂. The applicants postulate that as an alternative other nitrification inhibitors can be used, such as 3,4-dimethylpyrazole phosphate (DMPP).

DCD can be regarded as a slow release N fertilizer (containing about 65% N), however this is not the purpose in the present invention of the proposed soil application. DCD inhibits the first stage of nitrification in soil, i.e., the oxidation of NH₄⁺ to NO₂⁻, by rendering the bacteria's enzymes ineffective. It is not a bactericide, and does not affect other heterotrophs that are responsible for much of the soil's biological activity.

The purpose of this invention is to treat the whole area of grazed pasture soil, including urine patch and non-urine patch areas, to reduce the nutrient losses from the animal urine and soil, rather than from the fertilizer per se, and also to increase pasture production from both the urine patch and non-urine patch areas in grazed pasture systems.

The effective performance of DCD in reducing NO₃⁻—N leaching and nitrous oxide emissions from urine patches compared to the performance reported from other studies, where DCD was either applied alone or combined with N fertilizers in cropping systems or applied with manure or dairy effluent, is related to the manner in which DCD is applied. When DCD is applied in solution form and/or fine particle suspension form it is highly effective at reducing the leaching of nitrate, K, Ca, Mg, reducing nitrous oxide emissions and increasing pasture production.

The application in solution form and/or fine particle suspension form helps the inhibitor to permeate throughout the soil surface layer enabling it to treat a greater soil volume, slowing down its decomposition compared to situations where it remains on the soil surface following application in a solid form with N fertilizer. Multiple applications maintain the inhibition effect in the soil for a longer time period compared to a single application. Most other studies have either combined DCD with an N fertilizer applied in a solid form or mixed with a liquid manure or effluent in a single application.

One of the keys to using nitrification inhibitors to reduce the leaching of NO₃⁻, K, Ca, and Mg and reduce nitrous oxide emissions from grazed pasture soils is the delivery of the inhibitor over the entire soil surface, including the urine patches. This is achieved by applying DCD to the whole area of the grazed pasture soil in liquid form and/or fine particle suspension form for example through the irrigation system, as described in the example method below.

Where farms are not irrigated, then the inhibitor can be applied by a spray vehicle in a similar way as agricultural chemicals (e.g. herbicides) are applied.

Further aspects of the invention will become apparent from the following descriptions which are given by way of example.

### Description of the Drawings and Tables

FIG. 1. Shows total annual NO₃⁻—N leached from the treatments as measured on lysimeters, with and without a nitrification inhibitor (DCD).

FIG. 2. Shows pasture yield as affected by the treatments measured on the lysimeters, with and without a nitrification inhibitor (DCD).

FIG. 3. Shows pasture N off-take as affected by the treatments measured on the lysimeters, with and without a nitrification inhibitor (DCD).

FIG. 4. Shows nitrous oxide emissions from animal urine patches as affected by the treatments measured on the lysimeters, with and without a nitrification inhibitor (DCD).

FIG. 5. Shows a nitrification inhibitor applied through a centre pivot irrigation system.

FIG. 6. Shows a nitrification inhibitor applied through a travelling irrigator.

FIG. 7. Shows the active soil zone of the inhibitor, with and without irrigation.

FIG. 8. Shows a pumping system for delivery of a nitrification inhibitor through an irrigation system.

FIG. 9. Shows a nitrification inhibitor being delivered by an agricultural spray vehicle.

Table 1. Shows calculated paddock-averaged annual NO₃⁻—N leaching losses and concentrations in the drainage water, with and without a nitrification inhibitor (DCD).

Table 2. Shows annual average pasture yield in urine patch and non-urine patch areas with and without a nitrification inhibitor (DCD) applied at 15 kg ha⁻¹ y⁻¹ to field plots on a Temuka soil type.

Table 3. Shows nitrous oxide emissions, with and without a nitrification inhibitor (DCD).

Table 4. Shows calculated paddock-averaged potassium, calcium and magnesium leaching losses, with and without a nitrification inhibitor (DCD).

### MODES FOR CARRYING OUT THE INVENTION

Modes of carrying out the invention will become apparent from the following descriptions which are given by way of example only.

### EXAMPLE 1

Lysimeter studies, which are state-of-the-art technology for these investigations, have shown the effectiveness of a nitrification inhibitor, dicyandiamide (DCD), in reducing NO₃⁻—N leaching from a grazed dairy pasture under irrigation. This example used a free-draining Lismore stony silt loam (Udic Haplustept loamy skeletal) and the pasture was a mixture of perennial ryegrass (Lolium perenne) and white clover (Tifolium repens) but the process is applicable to all temperate soils and animal grazing systems.

Undisturbed soil monolith lysimeters, 50 cm diameter and 70 cm deep, were collected following well-established protocols and procedures that ensure there is minimal disturbance to the soil structure inside. The lysimeters were transported to a lysimeter facility near Lincoln University, using a specially designed trailer with air-bag suspension to minimize disturbance. The gap between the soil core and the metal casing was sealed using petroleum jelly to stop edge-flow effects. The lysimeters were then installed in the field lysimeter facility with the surface of the lysimeters at the same level as that of the surrounding soil surface, in order to maintain normal plant growing conditions.

Each treatment had 4 replicates. The treatments were allocated to the lysimeters in a randomised design. The urea application rate of 200 kg N ha⁻¹ y⁻¹ was at the higher end of fertilizer N application rates for most farmers in the region. The rates of urea were either split into 8 applications to maximize N efficiency, or 4 applications as a cost cutting measure (i.e. reducing application costs). Urine was applied either in the spring (November) or in the autumn (April) to simulate urine patches deposited in the spring or autumn by a grazing dairy cow. The urine application rate of 1000 kg N ha⁻¹ was equivalent to the typical N loading rate under a cow urine patch. The combination of urea with urine treatments was included to represent a situation where urea was applied throughout the paddock, and patches of the paddock received cow urine. Two rates of phosphate (P) fertilizer were applied, 45 or 90 kg P ha⁻¹ y⁻¹, to represent the range of P application rates used by local dairy farmers. As the purpose of this study was to determine the effectiveness of DCD in reducing NO₃⁻ leaching from grazed pasture soil including cow urine patch areas, DCD was either applied or withheld. The DCD was applied in a liquid form to simulate application in the irrigation water on irrigated dairy farms or by spray vehicle.

Urea was applied in solid form and was broadcast over the surface of the lysimeters followed by 10 mm of irrigation. Irrigation following urea application has been shown to significantly reduce ammonia loss by volatilization.

Fresh urine was collected early in the morning during the milking session from Friesian cows, and was analysed and applied to the lysimeters on the same day. The same volume of water was applied to the other lysimeters that did not receive urine in order to maintain the same moisture input to all lysimeters.

DCD was applied in solution form (100 mL per lysimeter) at the rates of 7.5 kg ha⁻¹ after each urea application in the same day, or 15 kg ha⁻¹ immediately after each urine application. The DCD solution was sprayed onto the lysimeters with a watering can, simulating an application by an irrigator or spray vehicle.

From November to April (late spring to mid autumn), flood irrigation, at 100 mm, was applied to all the lysimeters at about three weekly intervals. The amount of water applied was to represent the average amount of water applied on commercial flood-irrigated dairy farms. Irrigation water was applied using an electronically controlled metering system to deliver the required volume of water to the lysimeters. From May to October (late autumn to mid spring), simulated rainfall was applied at the end of each month (if necessary), to supplement the natural rainfall received in order to equal the 75th percentile of local rainfall records for the same period of the year. This was done to create a so-called ‘worst case scenario’ in terms of rainfall inputs and to ensure a standard condition was achieved.

The herbage was cut periodically to simulate typical grazing practice. All the harvested herbage was removed and dry matter yield recorded. Herbage nitrogen content was analysed. Following each herbage cut, a specially designed mechanical cow hoof was used to simulate cow treading on the lysimeters. The mechanical hoof is made of stainless steel with identical shape and size as an adult Friesian cow hoof. The hoof is mounted onto a compressed air-ram, which is driven by an air compressor system to provide a treading pressure of 220 kPa to simulate the treading pressure exerted by a cow's hoof during walking. The entire surface of the lysimeters was trodden once following each herbage cut. This was based on the inventors observation of hoof print coverage following each grazing rotation.

Nitrous oxide emissions from two treatments were determined using a closed chamber method. The enclosed chamber was fitted on top of the lysimeters inside a rubber ring on top of the lysimeter casing. At each sampling time, 3 samples, 10-15 minutes apart, were taken. Nitrous oxide was analysed using gas chromatography and daily N₂O fluxes were calculated based on daily mean temperatures.

A field plot experiment was established on a Temuka soil on the Lincoln University Dairy farm to determine pasture response to DCD applications. A total of six plots, each 100 m² in area were set up. Fresh cow urine was collected from dairy cows and was analysed for N concentration. The urine was then applied to eight areas (0.2 m² each) within each plot to simulate urine patches deposited by the grazing cow. Urea was applied to the plots as per the rest of the farm at 200 kg N/ha. Phosphate fertilizer (superphosphate) was applied at 45 kg P/ha per year as per the rest of the dairy farm.

Three of the plots received the DCD treatment DCD was applied in a solution form to the whole area of each plot by spray equipment similar to those used to spray other agrochemicals. The DCD was applied twice each year (one in the autumn (May) and one in the spring (August)) at 10-15 kg/ha for each application.

Spray irrigation was applied between spring and autumn when necessary through a central pivot irrigator as per the rest of the dairy farm. Pasture from the simulated urine patch areas and from adjacent non-urine patch areas was cut and removed. Following the pasture cut, the plots were then grazed by dairy cows.

Dry matter yield was recorded from the urine patch and non-urine patch areas (Table 2). Pasture yield was calculated at the paddock scale as described above (Table 2).

TABLE 1
Calculated paddock-averaged annual NO₃⁻—N leaching losses and
concentrations in the drainage water, with and without a nitrification
inhibitor (DCD).

| | Leaching losses | Paddock averaged |
|---|---|---|
| Management | from paddock^{c} | concentration |
| condition | (kg N ha⁻¹ y⁻¹) | (mg N L⁻¹) |
| Urea 200 + grazing^{a} | 118.2 | 19.7 |
| Urea 200 + grazing + DCD^{b} | 46.1 | 7.7 |

^{a}Assuming that urea was applied at 200 kg N ha⁻¹ y⁻¹ throughout the paddock, and urine patches covered 25% of the paddock (equivalent to 3 cows per ha.).
^{b}As above except with DCD applied, as described in the text.
^{c}To calculate these values, annual leaching losses from urine areas were the averages of those from the urine applied in the spring and autumn. The autumn leaching losses were the averages of the P45 and P90 treatments. The leaching losses from the urea 200 treatment with DCD were assumed to be 59.1% less than that from the urea 200 treatment without DCD.

TABLE 2
Annual average pasture yield in urine patch and non-urine patch areas
with and without a nitrification inhibitor (DCD) applied at 15 kg ha⁻¹ y⁻¹
to field plots on a Temuka soil type.

| Management | Pasture yield |
|---|---|
| condition | (t ha⁻¹ y⁻¹) |
| No DCD applied | |
| Urine patch areas | 13.4 |
| Non-urine patch areas | 10.3 |
| With DCD applied | |
| Urine patch areas | 15.1 |
| Non-urine patch areas | 12.3 |
| Paddock averaged yields | |
| No DCD^{a} | 11.1 |
| With DCD applied^{b} | 13.0 |

^{a,b}Similar assumptions were made as those for calculating NO₃⁻—N leaching losses in Table 1.

TABLE 3
Shows nitrous oxide emissions, with and without a nitrification inhibitor
(DCD) applied. (Numbers in brackets are standard error of the mean.)

| | Total nitrous oxide emission |
|---|---|
| Treatment | (kg N₂O/ha) |
| Autumn application | |
| Urine (no DCD) | 26.7 (5.9) |
| Urine + DCD | 7.0 (2.3) |
| Spring application | |
| Urine (no DCD) | 18.0 (2.9) |
| Urine + DCD | 4.5 (0.7) |

TABLE 4
Shows calculated paddock-averaged potassium, calcium and magnesium
leaching losses, with and without a nitrification inhibitor, assuming 25%
of the area is covered by urine patches.

| | Leaching losses (kg ha⁻¹y⁻¹) | | |
|---|---|---|---|
| Cation | Without DCD | With DCD | % decrease due to DCD |
| Calcium | 213 | 107 | 50% |
| (Ca²⁺) | | | |
| Potassium | 48 | 17 | 65% |
| (K⁺) | | | |
| Magnesium | 17 | 8 | 52% |
| (Mg²⁺) | | | |

### EXAMPLE 2

Delivery Systems for Applying a Nitrification Inhibitor through an Irrigation System

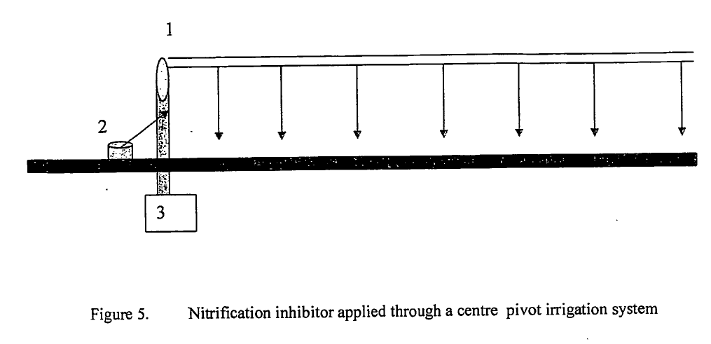

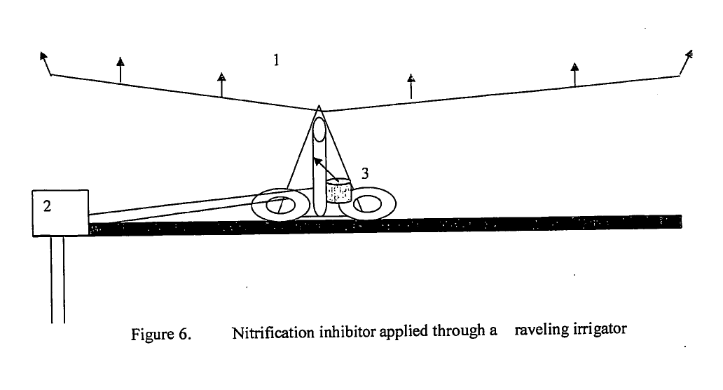

The intent is to spread the nitrification inhibitor evenly over the whole surface of the pasture soil by applying it through an irrigation system (such as centre pivot or travelling irrigator) where there is an ability to control and vary the application volume and rate of application according to the conditions in the soil (an example applicator is illustrated in FIGS. 5 and 6).

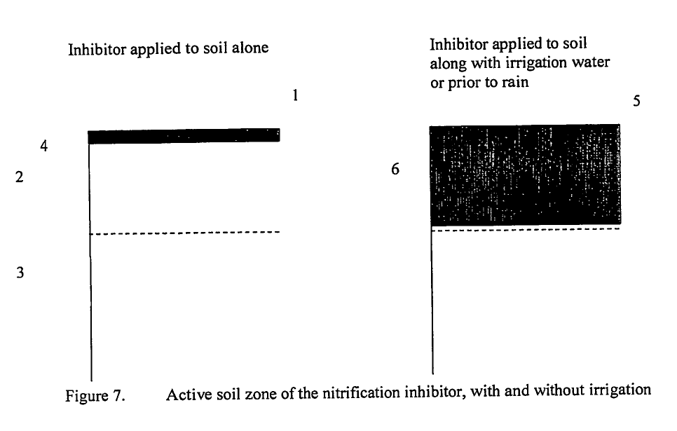

Delivery of the inhibitor in solution and mixed with the irrigation water ensures that the inhibitor penetrates throughout the soil surface. The ability to control the penetration of the inhibitor through the soil volume is a key determinant of the effectiveness of the compound. The effectiveness of the inhibitor is increased by distribution throughout, and thus treats, a larger volume of soil (FIG. 7) than it would if the inhibitor alone was sprayed onto the pasture soil surface. This is an advantage of such a delivery system where the soil moisture content varies from wilting point to field capacity throughout the year and in turn affects the flow of the applied solution.

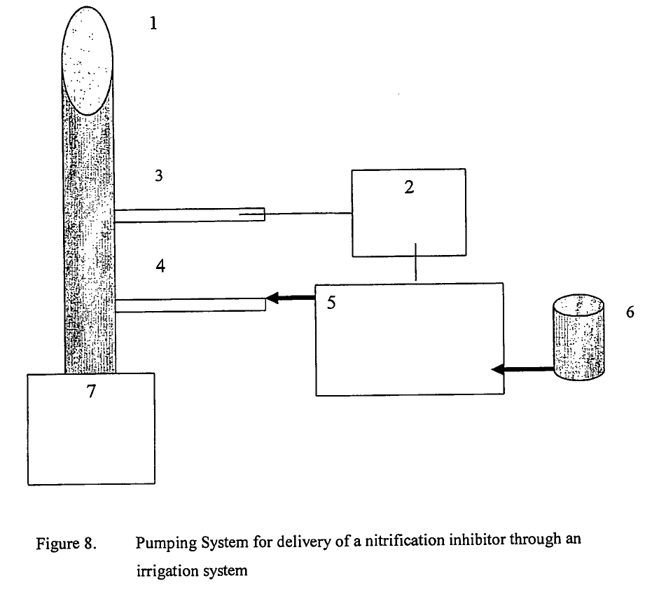

A computer controlled pumping system can be part of the inhibitor delivery system. The nitrification inhibitor solution at a concentration dependent on the level of control required over the processes in the soil is injected from a supply tank into the irrigation water using a flow rate controlled pump connected to the irrigation delivery pipe or irrigation hose (as illustrated in FIG. 8).

The timing of application is important to the success of the process. The irrigator and pumping systems are controlled such that the nitrification inhibitor is applied to the paddock soon after grazing, when the urine patches are fresh, by following the grazing rotation. This is particularly important for the autumn grazing rotations.

### EXAMPLE 3

Delivery of a Nitrification Inhibitor Using Agricultural Chemical Spray Equipment

The nitrification inhibitor can be delivered evenly over the soil surface using agricultural chemical spray equipment (e.g., equipment currently used to apply agricultural chemicals such as herbicides or pesticides).

The nitrification inhibitor is delivered/dissolved in water and the solution and/or fine particle suspension is sprayed onto the whole surface of the grazed pasture soil from a tank of an agricultural spray vehicle.

The spray equipment can be used to apply the nitrification inhibitor immediately after grazing when the animal urine patches are ‘fresh’, this can be particularly effective during autumn grazing rotations.

Following the spray application by this method irrigation water can be applied to ‘wash’ the nitrification inhibitor into the topsoil. This will ensure that the nitrification inhibitor is distributed evenly throughout, and thus treats, the topsoil.

If irrigation is not applied then the nitrification inhibitor can be applied immediately prior to rainfall. The rain will ‘wash’ the inhibitor into the topsoil and thus ensure that this larger volume of soil is treated.

Advantages

The invention provides a number of advantages some of which are listed below.

1. The NO₃⁻—N concentration in the drainage water from a grazed dairy pasture soil is reduced accordingly from 19.7 to 7.7 mg N L⁻¹, with the latter being below the World Health Organisation and New Zealand Ministry of Health drinking water guideline of 11.3 mg N L⁻¹ (Table 1).

2. A solution of nitrification inhibitor (DCD) when applied at a frequency and timing to a grazed dairy pasture increases pasture production from the whole of the grazed pasture by more than 15% (e,g, from 11.1 to 13.0 t ha⁻¹ y⁻¹) (Table 2).

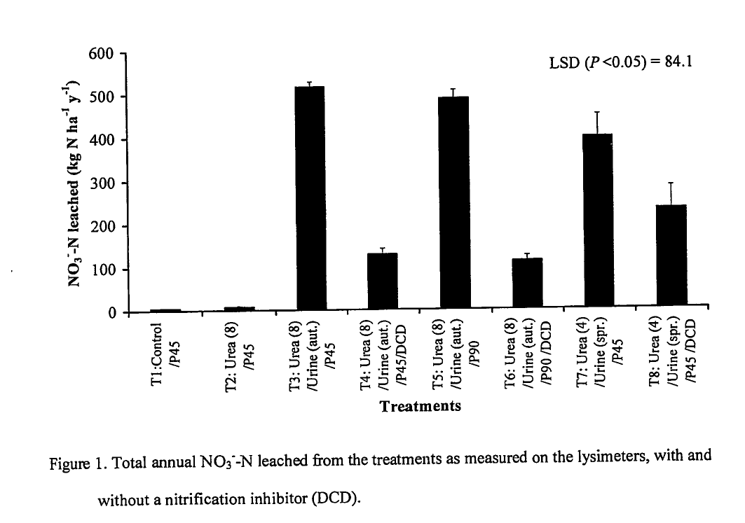

3. Total annual NO₃⁻—N leaching losses measured from the lysimeters were low in the Control (4.8 kg N ha⁻¹ y⁻¹) and in the Urea 200 treatment (Treatment 2: 7.9 kg N ha⁻¹ y⁻¹) (FIG. 1). In Treatment 3 where urine was applied in the autumn without DCD, total NO₃⁻—N leaching loss was equivalent to 516 kg N ha⁻¹ y⁻¹ (i.e. directly below the urine patch). This was reduced to 128 kg N ha⁻¹ y⁻¹ when DCD was applied (Treatment 4) (FIG. 1).

4. Similarly, in the P 90 treatments (cf. Treatments 5 and 6), the application of DCD reduced total annual NO₃⁻—N leaching loss from 488 to 112 kg N ha⁻¹ y⁻¹. Where the urine was applied in the spring (cf. Treatments 7 and 8), the application of DCD reduced total annual NO₃⁻—N leaching loss from 397 to 230 kg N ha⁻¹ y⁻¹ (FIG. 1). These results show that the application of DCD reduced NO₃⁻—N leaching by an average of 76.1% for the urine-N applied in the autumn, and by 42.1% for the urine N applied in the spring.

5. When urea was applied at 200 kg N ha⁻¹ y⁻¹ throughout the paddock and the paddock was grazed by 3 cows per ha, the average annual NO₃⁻—N leaching loss from the whole paddock was estimated to be 118 kg N ha⁻¹ y⁻¹ without DCD. This was reduced to 46 kg N ha⁻¹ y⁻¹ (Table 1) when DCD was applied to the whole area of the grazed pasture soil. The application of DCD would reduce the NO₃⁻—N concentration in the drainage water from 19.7 to 7.7 mg N L⁻¹. The latter was below the drinking water guideline of 11.3 mg N L⁻¹ set by the New Zealand Ministry of Health. Most of the NO₃⁻—N leached was contributed by that leached from the urine patch areas (Table 1).

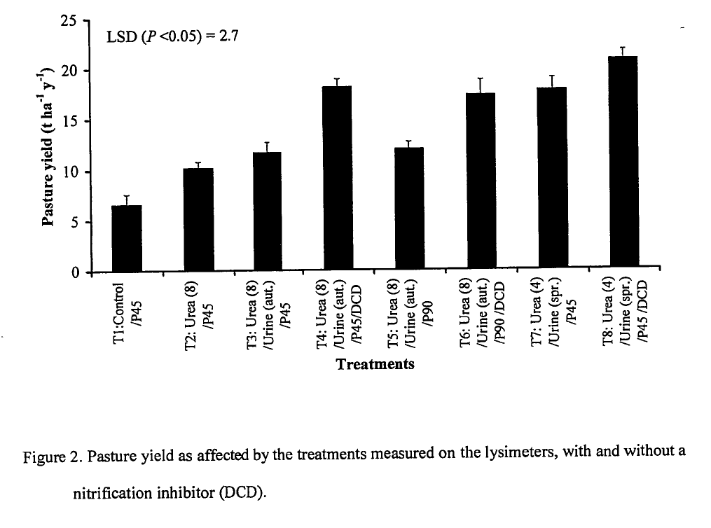

6. The application of DCD increases pasture yields (FIG. 2). The increases in pasture yields were particularly evident in the autumn urine treatments (cf. Treatments 3 and 4; and 5 and 6 in FIG. 2). The application of DCD increased pasture yields in the autumn urine treatments by an average of 49%, while the increase in the spring urine treatments was equivalent to 17.5%. This gave an annual average increase of more than 15% in pasture production by treating the whole surface area with DCD. The pasture yields were higher in the spring urine treatments than in the autumn urine treatments.

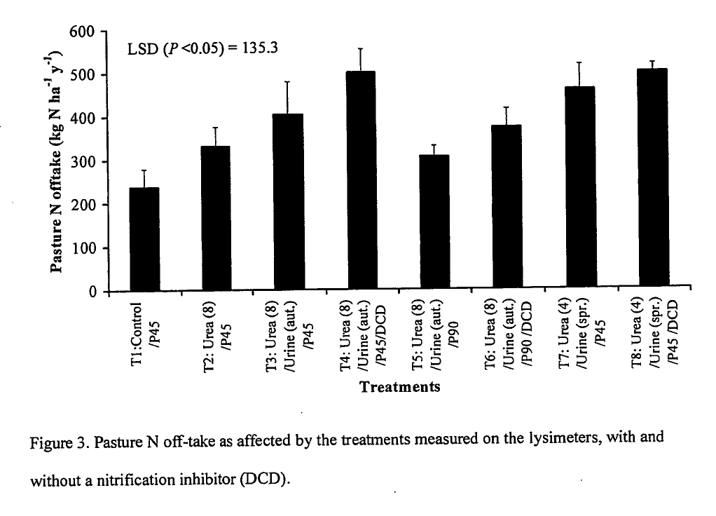

7. The increases in pasture N off-take as a result of DCD application were equivalent to 23% for the autumn urine treatments, and 9% for the spring urine treatments, giving an annual average of 16% (FIG. 3).

8. Pasture yields were also found to increase in large field plots treated with DCD. This trial showed that the annual pasture yield in the urine patch areas increased from 13.4 to 15.1 t ha⁻¹ y⁻¹ when DCD was applied to the whole area of the grazed pasture soil in the field plots (Table 2). Pasture yield was also increased in the non-urine patch areas from 10.3 to 12.3 t ha⁻¹ y⁻¹ when DCD was applied to the whole area of the grazed pasture soil in the field plots (Table 2). The calculated average paddock yield increased from 11.1 to 13.0 t ha⁻¹ y⁻¹ when DCD was applied to the whole area of the grazed pasture soil in the field plots (Table 2).

9. The application of DCD applied in solution or fine particle suspension forms to the whole area of grazed pasture soil appears to be a very effective management tool to reduce NO₃⁻—N leaching in a grazed pasture system. The use of DCD alone could reduce NO₃⁻—N concentration in the drainage water from 19.7 to 7.7 mg N L⁻¹ in a shallow and stoney free-draining Lismore soil which is a soil that has a very high leaching potential. Therefore, with the use of DCD, the NO₃⁻—N concentration in the drainage water from free-draining soils can be reduced significantly below the drinking water guideline of 11.3 mg N L⁻¹.

10. For instance, combined DCD with farm dairy effluent (dirty water) reported only an 18% reduction in the amount of NO₃⁻—N leached. This was significantly lower than the 42.1-76.1% reductions in the amount of urine N leached as measured in this study.

11. The rate of DCD decomposition increases with temperature. This is probably one of the reasons why the reduction in NO₃⁻— leaching from the spring urine application was smaller than that from the autumn urine application, as the DCD would have been decomposed more rapidly under the warmer summer temperatures. However, the fact that DCD was only applied 5 times in the spring urine treatment compared to 9 applications in the autumn urine treatments might also have played a part in contributing to the differences in the DCD effect. In line with findings in a previous study using the same soil the amount of NO₃⁻—N leached from the spring urine without DCD was lower than that from the autumn urine partly due to greater pasture N off-take of the spring urine N (FIG. 3). The optimum frequency and amount of DCD application are the subject of the inventors' current investigations. Indications are that it may be possible to use two applications per year (e.g. spring and autumn) to achieve similar results as described above.

12. The use of DCD increases pasture production (FIG. 2, Table 2). The slow down of nitrification therefore preserves the N in the NH₄₊ form for a longer period, making it more accessible for pasture uptake. This increase in pasture production in both the urine patch and non-urine patch areas (Table 2) is an added benefit from applying DCD onto the whole area of grazed pasture soils. The additional amount of N applied from the DCD was small (20-49 kg N ha⁻¹ y⁻¹), particularly compared with the 1000 kg ha⁻¹ of urine N applied, the effect on pasture production by the DCD-N alone was, therefore, probably limited.

13. The amount of NO₃⁻—N leached from the Urea 200 treatment (8 kg N ha⁻¹ y⁻¹, Treatment 2, FIG. 1) was slightly lower than that (17 kg N ha⁻¹ y⁻¹) from a previous study using the same soil. This difference in leaching loss was probably because the 200 kg of urea N in this study was split into 8 applications whereas in the previous study, it was split into 4 applications. The practice of more frequent applications of smaller amounts of N was thus probably slightly more efficient than that of fewer applications at greater amounts.

14. By treating the whole area of grazed pasture soil with DCD, including the urine and non-urine patch areas, the amount of NO₃⁻ leaching can be dramatically reduced. The use of DCD reduced NO₃⁻—N leaching by 76% for the urine N applied in the autumn, and by 42% for urine N applied in the spring, giving an annual average reduction of 59%. This was found to reduce the NO₃⁻—N leaching loss in the whole area of a grazed paddock from 118 to 46 kg N ha⁻¹ y⁻¹.

15. The NO₃⁻—N concentration in the drainage water was reduced accordingly from 19.7 to 7.7 mg N L⁻¹, with the latter being below the drinking water guideline of 11.3 mg N L⁻¹. In addition to the environmental benefits, the use of DCD also increased pasture production by more than 15%, from 11.4 to 15.0 t ha⁻¹ y⁻¹.

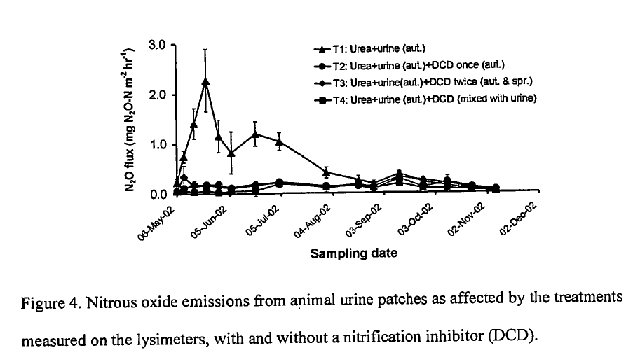

16. Nitrous oxide (N₂O) emissions following urine application in autumn were reduced from 26.7 kg N₂O—N ha⁻¹ without DCD to 7.0 kg N₂O—N with DCD (Table 3 and FIG. 4); and following a spring application were reduced from 18.0 kg N₂O—N ha⁻¹ without DCD to 4.5 kg N₂O—N ha⁻¹ with DCD applied (Table 3).

17. These results suggest that the effective use of DCD has the potential to transform grazed pasture systems to a more environmentally sustainable basis by reducing NO₃⁻—, K, Ca and Mg leaching and N₂O—N losses.

18. The application of a nitrification inhibitor (e.g. DCD) reduced calcium (Ca²⁺) leaching by 50% (from 213 to 107 kg/ha/y), reduced potassium (K⁺) leaching by 65% (from 48 to 17 kg/ha/y) reduced magnesium (Mg²⁺) leaching by 52% (from 17 to 8 kg/ha/y) (Table 4). This would provide economic benefit to the farmer in reduced fertilizer costs.

19. The delivery system for applying an active nitrification inhibitor through an irrigation system can produce the effects described above.

20. The delivery system for applying an active nitrification inhibitor using agricultural chemical spray equipment can produce the effects as described above.

In FIG. 5 is shown a centre pivot irrigation system 1 suitable for application of a nitrification inhibitor in solution or fine particle suspension form. The supply of the nitrification inhibitor to the irrigation water can be from reservoir 2 by way of a venturi pipe or pump. The irrigation water being supplied from an underground water supply 3 or irrigation supply system.

In FIG. 6 is shown a travelling irrigator 1 suitable for application of a nitrification inhibitor in solution or fine particle suspension form. The supply of the nitrification inhibitor to the irrigation water can be from reservoir 3 by way of a venturi pipe or pump. The irrigation water is supplied from an underground water supply 2 or irrigation system.

In FIG. 8 is shown a delivery system suitable for delivering at a controlled rate a nitrification inhibitor to an irrigation system. The irrigation water plus nitrification inhibitor 1 is delivered at a controlled rate to an irrigator (not shown). The rate of nitrification inhibitor supply is controlled by a control system 2 which monitors a flow rate sensor 3. The control system 2 monitors and controls the supply of nitrification inhibitor from reservoir 6 through injection pump 5 to a control valve 4. The control system 2 operates in conjunction with an irrigation pump 7 to supply the irrigation water for the irrigator.

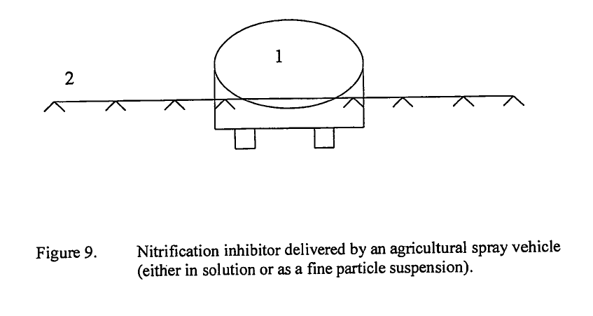

In FIG. 9 is shown diagrammatically the application of a nitrification inhibitor delivered by an agricultural spray vehicle. The vehicle has a tank 1 containing a nitrification inhibitor solution or fine particle suspension and a spray boom 2 for applying inhibitor over the soil surface.

Where in the description and examples particular integers are mentioned it is envisaged that their equivalents may be substituted as if they were individually set forth herein.

Particular examples of the invention have been described and it is envisaged that improvements and modifications can take place without departing from the scope of the attached claims.

1-35. (canceled)

36. A method for soil management in pasture farming systems, comprising applying a nitrification inhibitor in solution form, fine particle suspension, or crystalline form to treat an entire area of grazed pasture soils, to reduce at least one of (1) NO₃⁻—N leaching, (2) nitrous oxide emission; and (3) potassium, calcium or magnesium leaching, whereby pasture production in both animal urine patch areas and non-urine patch areas is increased.

37. A method according to claim 36, wherein the nitrification inhibitor is applied in conjunction with either irrigation water by a spray vehicle, or by conventional method for application of agricultural chemicals.

38. A method according to claim 36, wherein the nitrification inhibitor is applied in the autumn at a frequency and time that reduces NO₃⁻—N leaching by about 76% for urine-N.

39. A method according to claim 36, wherein the nitrification inhibitor is applied in the spring at a frequency and time that reduces NO₃⁻—N leaching by about 42% for urine-N.

40. A method according to claim 38, wherein the nitrification inhibitor is further applied in the spring at a frequency and time that reduces NO₃⁻—N leaching by about 42% for urine-N, resulting in a annual average reduction of about 59%, which is equivalent to reducing NO₃⁻—N leaching loss in a grazed pasture from about 118 to about 48 Kg N ha⁻¹ y⁻¹.

41. A method according to claim 36, wherein the nitrification inhibitor is dicyandiamide (DCD), nitropyrin or 3,4-dimethylpyrazole phosphate (DMPP).

42. A method according to claim 36, wherein the nitrification inhibitor is in the form of solution or fine particle suspension, whereby permeation of the inhibitor throughout a soil surface layer is enhanced, increasing the soil volume treated and slowing down the decomposition of the inhibitor.

43. A method according to claim 36, wherein the nitrification inhibitor is applied multiple times to maintain and prolong the inhibition effect in the soil.

44. A method according to claim 36, wherein the nitrification inhibitor is applied in crystalline form, which allows for its dissolution by rain or irrigation water.

45. A method according to claim 36, wherein the NO₃⁻—N concentration in a drainage water from the grazed dairy pasture soil is reduced from about 19.7 to about 7.7 mg N L⁻¹.

46. A method according to claim 41, wherein a solution of DCD is applied to the grazed pasture at a frequency and timing to increase pasture production from the whole of grazed pasture by more than 15%.

47. A method according to claim 46, wherein the application of DCD reduces total annual NO₃⁻—N loss from about 488 to about 112 kg N ha⁻¹ y⁻¹.

48. A method according to claim 41, wherein urea is applied at 200 kg N ha⁻¹ y⁻¹ throughout the pasture and the pasture is grazed by 3 cows per ha., wherein DCD is applied to the whole area of the grazed pasture soil, and wherein the average annual NO₃⁻—N leaching loss is reduced from about 118 kg N ha⁻¹ y⁻¹ to about 46 kg N ha⁻¹ y⁻¹.

49. A method according to claim 41, wherein pasture N off-take as a result of DCD application is increased by an equivalent of about 23% for autumn urine treatments, and about 9% for spring urine treatment, resulting in an annual average of about 16%.

50. A method according to claim 41, wherein DCD application to the whole area of grazed pasture soil increases pasture yield from about 11.1 t to about 13.0 t ha⁻¹ y⁻¹.

51. A method according to claim 41, wherein DCD is applied five times in a spring urine treatment, or nine times in an autumn urine treatment, or both.

52. A method according to claim 41, wherein DCD is applied in a spring and an autumn application each year.

53. A method according to claim 36, wherein application of the nitrification inhibitor reduces calcium leaching by about 50% (from about 213 to about 107 kg/ha/y), potassium leaching by about 65% (from about 48 to about 17 kg/ha/y), and magnesium leaching by about 52% (from about 17 to about 8 kg/ha/y).

54. A method according to claim 36, wherein application of the nitrification inhibitor reduces nitrous oxide emission following urine application in the autumn from about 26.7 kg N₂O—N ha⁻¹ to about 7.2 kg N₂O—N ha⁻¹.

55. A method according to claim 36, wherein application of the nitrification inhibitor reduces nitrous oxide emission following urine application in the spring from about 18.0 kg N₂O—N ha⁻¹ to about 4.5 kg N₂O—N ha⁻¹.

56. A delivery mechanism for applying a nitrification inhibitor, which is in solution, in fine particle suspension, or both, to the whole area of soil in a grazed pasture system, wherein the nitrification inhibitor reduces at least one of (1) NO₃⁻—N leaching, (2) nitrous oxide emission; (3) potassium, calcium or magnesium leaching, whereby pasture production in both animal urine patch areas and non-urine patch areas is increased, wherein the nitrification inhibitor is applied in conjunction with either irrigation water, or applied as conventional agricultural chemicals.

57. A delivery mechanism according to claim 56, wherein the nitrification inhibitor is supplied to an irrigator by a computer controlled system.

58. A delivery mechanism according to claim 56, wherein the nitrification inhibitor is injected from a supply tank into irrigation water using a flow rate controlled pump connected to an irrigation delivery pipe or irrigation hose.
